(19) United States
(12) Patent Application Publication
(10) Pub. No.: US 2018/0267553 A1
(43) Pub. Date: Sep. 20, 2018

(54) METHOD FOR OPERATING A SYSTEM OF AN AGRICULTURAL MACHINE AND AT LEAST ONE DEVICE ARRANGED THEREON

(71) Applicant: ZF Friedrichshafen AG, Friedrichshafen (DE)

(72) Inventor: Thomas EBERTSEDER, Pocking (DE)

(21) Appl. No.: 15/915,495

(22) Filed: Mar. 8, 2018

(30) Foreign Application Priority Data
Mar. 16, 2017 (DE) 10 2017 204 433.0

(51) Int. Cl. G05D 1/02; A01B 69/04; A01B 69/00

(52) U.S. Cl. CPC G05D 1/0223; G05D 2201/0201; A01B 69/004; A01B 69/008

(57) ABSTRACT

A method for operating a system including an agricultural working vehicle on which at least one working device is arranged, which working device, when moving across a field, is operated along a current linear row. A control unit is associated with the working vehicle and the sensor unit is arranged on the working device. The sensor unit includes an acceleration sensor, a memory unit and a transmitter unit, which wirelessly communicate with one another. The at least one acceleration sensor continually sends signals to the control unit that represent vertical accelerations and which are evaluated in order to determine movement amplitudes of the working device so that, as a function of the movement amplitudes, a maximum travel speed is determined, which ensures that the at least one working device will stay on its current linear row while driving across the field.

This application claims priority from German patent application serial no. 10 2017 204 433.0 filed Mar. 16, 2017.

### FIELD OF THE INVENTION

The invention concerns a method for operating a system comprising an agricultural working vehicle and at least one working device arranged on it. In addition the present invention concerns a system comprising an agricultural working vehicle and at least one working device arranged on it, and a control unit for a system comprising an agricultural working vehicle and at least one working device arranged on it.

### SUMMARY OF THE INVENTION

Generally speaking, a system comprising an agricultural working vehicle and at least one working device arranged on it forms the basis for working on a field used for agricultural purposes. By means of the agricultural vehicle the working device is moved over the field and is driven by an auxiliary power take-off in order to carry out work operations such as tillage, sowing, planting, harvesting, fertilizing or spraying. During this, while moving over the field the working device usually travels along linear rows with specified lateral distances between the linear rows which have to be maintained. Moreover, within each row defined distances are allowed between individual plants of the crop, these distances being chosen depending on the crop. The lateral distances between adjacent linear rows and the distances within a given row, i.e. the plant separation parameters, are chosen such that for the crop concerned the greatest possible yield per unit surface area is ensured. Thus, in carrying out the various operations a high level of precision is required.

The system comprising a working vehicle with a working device arranged on it is driven by an operator who determines the speed of the vehicle while driving over the field. For this a control unit is associated with the working vehicle, which can be designed to set and maintain a constant travel speed. The travel speed is specified by the operator on the basis of his subjective impressions of the ground condition of the field to be worked on in each case. If the control unit is not set up to maintain a constant speed of travel, the operator has to actively control the travel speed.

EP 2 907 385 A1 describes a method for operating a system comprising an agricultural vehicle in the form of a tractor and a field sprayer arranged on the working vehicle. The field sprayer has a linkage which, due to the fact that working widths are continually increasing, is exposed to ever-higher mechanical loads due to inertial forces when traveling round curves. To detect the mechanical loads an acceleration sensor is arranged on the linkage which, if a mechanical load is imposed on the linkage that exceeds the damping properties of damping means arranged on the linkage, registers the value of the mechanical load. That value is sent to an output device in the cabin of the tractor in order to alert the tractor operator that there is a high mechanical load on the linkage of the field sprayer which could result in damage to the linkage or to increased wear of the damping means. By virtue of the display of such mechanical load peaks on the output device, the operator should be warned to adapt the travel speed or the mode of driving.

### SUMMARY OF THE INVENTION

Starting from the above-described prior art, the purpose of the present invention is now to provide a method for operating a system comprising an agricultural working vehicle and at least one working device arranged on it, and a system comprising an agricultural vehicle and at least one working device arranged on it, in order to achieve improved quality and quantity in the operation of the system. In other words, having regard to the achievement of the greatest possible yield, the working of a field should take place as quickly as possible.

From the process-technological standpoint and an equipment-technological standpoint the objectives are achieved by the characteristics specified in the independent claims. The other, dependent claims that follow each of these describe advantageous further developments of the invention. In addition, a control unit for a system comprising an agricultural vehicle and at least one working device arranged on it, which unit is also designed to carry out the method according to the invention, is the object of the independent claims.

According to the invention a method is proposed for operating a system comprising an agricultural vehicle with at least one working device arranged on it, which is operated along successive linear rows when working over a field. Agricultural vehicles include among others tractors, Trac-vehicles, equipment towing vehicles or self-driving harvesters, with the working device built onto or towed by the working vehicle. The system includes a control unit associated with the working vehicle as well as at least one sensor unit arranged on the working device, which sensor unit comprises an acceleration sensor, a memory unit and a transmitter unit.

The control unit and the at least one sensor unit communicate with one another by wireless means. The at least one acceleration sensor continually generates signals that represent vertical acceleration and transmits them from the transmitter unit to the control unit. The control unit evaluates the signals from the at least one acceleration sensor to determine movement amplitudes of the working device. Depending on the movement amplitudes determined by the control unit, a maximum travel speed is determined, which while driving over the field ensures that the at least one working device remains on track and that the plant separation specifications are complied with.

A working device operated along linear rows is regarded as a working device which has a plurality of working units arranged next to one another, which serve to work on or treat the surface of a field and a crop on it. The distances of the working units from one another define individual row separations within which the working of the field surface by the working device takes place. The quality of the work carried out on a field or field surface depends decisively on the maintenance of the row separations and the plant spacing. In particular, movements of the working device essentially in the vertical direction due to the speed of travel and the condition of the ground can result in failure to maintain those parameters, and this can influence the quality of the work done and/or the yield achieved by the work. In order to counteract that, the movement amplitudes of the working device are determined from the acceleration values detected by the at least one acceleration sensor.

Furthermore, their frequency can also be determined. Thus, the occurrence of vibrations in the working device can be detected. If the movement amplitudes exceed a threshold value that can be set as a parameter, the control unit determines a maximum travel speed. The maximum travel speed determined by the control unit is adapted for the condition of the ground and the movements of the working device that result therefrom, which can be deduced from the movement amplitudes. The parameterized threshold value indicates the order of magnitude of the movement amplitudes within which precise working by the working device is possible. These threshold values vary depending on the type and operating mode of the working device used in each case. Thus, having regard to the condition of the ground and hence the operating conditions when using the working device concerned at maximum efficiency, the greatest possibly precision in working the field can be achieved.

In contrast, the method according to EP 2 907 385 A1 takes into account only the travel speed and the driving mode, in that the influence on the mechanical loading of the working device in the form of a field sprayer in relation to its wear and useful life are monitored, but not the influence on the result of working the field or field surface by the working device.

The control unit associated with the working vehicle can be arranged in the working vehicle. Likewise, the control unit can be in the form of a mobile data receiver device which an operator of the working vehicle carries with him. For example, the mobile data receiver device can be in the form of a Smartphone or a Tablet PC. The wireless communication between the sensor unit and the control unit then takes place via Bluetooth by the transmitter unit integrated in the sensor unit. In that case the use of the Bluetooth Low Energy (BLE) radio standard is particularly appropriate since this results in a long operating life of the at least one sensor unit on the working device.

Preferably, the travel speed of the working vehicle can be adapted automatically by the control unit to the maximum travel speed determined. The automatic adaptation of the travel speed at the time to the ground condition has an approximately linear effect on the frequency of the movements and the movement amplitude of the working device. The automatic adaptation is advantageous when the control unit itself or an additional control device for adapting the current travel speed of the working vehicle are provided.

Furthermore, the maximum travel speed of the working vehicle determined by the control unit can be displayed on an output device. On the one hand the display shows the operator the effects of the travel speed chosen on the operating behavior of the working device. For this, the values received from the sensor unit can also be displayed. On the other hand, the display can also serve to instruct the operator to adapt the current travel speed manually if a corresponding control unit for automatic speed regulation of the working vehicle is not present.

According to a preferred further development, position signals from a position location system can be transmitted to the control unit, which are associated by the control unit with the respective signals received from the at least one acceleration sensor which represent vertical accelerations. For this the sensor unit can comprise an additional sensor designed to receive the position location signals. The position location signals, as also the signals from the acceleration sensor, are stored at least temporarily in the memory unit of the sensor unit so that they can also be read out at a later time.

Thus, the movement amplitudes detected and their frequency can be mapped by the control unit by way of the position signals. By means of the mapped data an individual movement profile for the system comprising the working vehicle and the working device that has worked over the field or suchlike can be prepared. Such a movement profile can be called up again when the system next works on the same field, in order to adapt the travel speed in advance. During this, new determinations of the vertical accelerations while working the field can be used to update the movement profile.

A preferred further development of the method provides that the signals from the at least one acceleration sensor are evaluated by the control unit in order to recognize the operating condition. For example, a corresponding evaluation of the signals from the at least one acceleration sensor indicates the number of hours for which the working device has been in operation, since the actual number of operating hours of the working device often does not correspond with the operating hours timer on the working vehicle owing to frequent changes of the working vehicle. In that way different operating conditions such as storage, transport and working operation of the working device can be recognized by the at least one movement sensor. From the data stored in the memory unit the respective durations of the various operating conditions can be determined.

Preferably, the transmitter unit of the sensor unit arranged on the working device can be assigned an individual code by the control unit, by referring to which the working device is identified by the control unit. The code can be a permanently assigned, clear address of the transmitter unit. With reference to the code specific data about the working device concerned can be called up by the control unit. The specific data can include, among other things, the type of the working device, its movement profile or the time for which it has operated, and specifications for the operation of the working device identified, such as a maximum drive torque. Thus, the control unit can send a signal to a transmission control system which provides a torque at the power take-off that is permissible for the working vehicle.

In addition the sensor unit can comprise a further sensor by which another physical magnitude is detected. For example, the sensor unit can also comprise a humidity sensor and a temperature sensor, or a filling level sensor.

The determination of the acceleration amplitudes by the control unit can be used for controlling the transmission control system. Such a combination can advantageously be used on working devices which are used for fluid output. For example, that could be a field sprayer or a slurry tanker with an exact distributor arranged on the working vehicle and powered by it. The continual variation of the filling level in the liquid container of the fluid output working device while driving over the field results, as it gets progressively emptier, in a variation of the movement amplitudes owing to the vertical acceleration when driving over uneven ground. This enables conclusions to be drawn about a filling level change in the liquid container. Since a working vehicle carrying a working device with a fuller liquid container needs different transmission settings than a working device with an empty liquid container, the transmission control system can be controlled appropriately. In addition a filling level sensor can be provided, which transmits filling level signals to the control unit whereby the control of the transmission control system can be made more precise.

According to the claims, to achieve the initially stated objective a system is proposed, which comprises an agricultural working vehicle and at least one working device arranged on it, which when working on a field is operated along linear rows. The system comprises a control unit associated with the working vehicle and on the working device at least one sensor unit that comprises an acceleration sensor, a memory unit and a transmitter unit, which communicate with one another by wireless means. The at least one acceleration sensor continually emits signals that represent a vertical acceleration to the control unit, which is designed to evaluate the signals in order to determine movement amplitudes of the working device and, depending on the movement amplitudes, to determine a travel speed which ensures that the at least one working device stays on track while driving over the field. The at least one sensor unit can preferably be arranged on exposed points of the working device. It is also conceivable to arrange a sensing device on the working device, which undergoes a deflection when the ground is uneven. On the sensing device, in turn, the at least one sensor unit is arranged. In this case the sensing device can be in the form of a feeler wheel arranged on a frame rack. By way of the frame rack the sensing device can be fixed detachably onto the working device.

It is advantageous that the at least one sensor unit can be retrofitted on the working device. This enables a subsequent use of the sensor unit which, by wireless means, in particular via the Bluetooth Low Energy radio standard, can communicate with the control unit which in the retrofitted case is in the form of a portable data receiving device. Thus there is no need to retrofit an additional control unit on the working vehicle. Instead, the portable data receiving device in the form of a Smartphone or Tablet is used. On the portable data receiving device the data registered by sensors and also the travel speed determined as a function of the movement amplitudes can be displayed almost in real time. Thus the operator can use that information to adapt the travel speed at the time objectively, with reference to the displayed measured values, to suit the condition of the ground and the movements of the attached device. For this a corresponding program code is stored on the portable data receiving device, which is designed to evaluate the signals form the acceleration sensor and to determine the maximum travel speed.

Furthermore the sensor unit can comprise at least one further sensor to detect another physical magnitude. For this the at least one further sensor can be designed as a humidity sensor and a temperature sensor.

In addition a control unit is proposed for a system comprising an agricultural working vehicle and at least one working device arranged on it, which is operated along linear rows when moving over a field, characterized in that the control unit is designed to carry out a method as described below.

Preferably the control unit can be designed to actuate a transmission control system. In such a case the actuation can take place as a function of the travel speed determined. Moreover, in the control unit an operating profile specific to the working device can be stored, which profile contains parameters for the transmission control system. By virtue of an identification of the working device by the sensor unit, the control unit can determine the specific operating profile.

The invention is not limited to the indicated combination of features in the independent claims or the claims that are dependent on them. There are in addition other possibilities for combining individual features with one another, providing that they emerge from the claims, from the description of preferred embodiments of the invention given below, or directly from the drawings. References in the claims to the drawings by the use of indexes are not intended to limit the protective scope of the claims.

### BRIEF DESCRIPTION OF THE DRAWINGS

Advantageous embodiments of the invention, which will be explained below, are illustrated in the drawings, which show:

FIG. 1: A schematic view of a system comprising an agricultural working vehicle and a working device;

FIG. 2: A schematic view of the system comprising an agricultural working vehicle and a working device, with a sensing device arranged on it; and

FIG. 3: A schematic representation of the structure of a sensor unit.

### DETAILED DESCRIPTION OF THE PREFERRED EMBODIMENTS

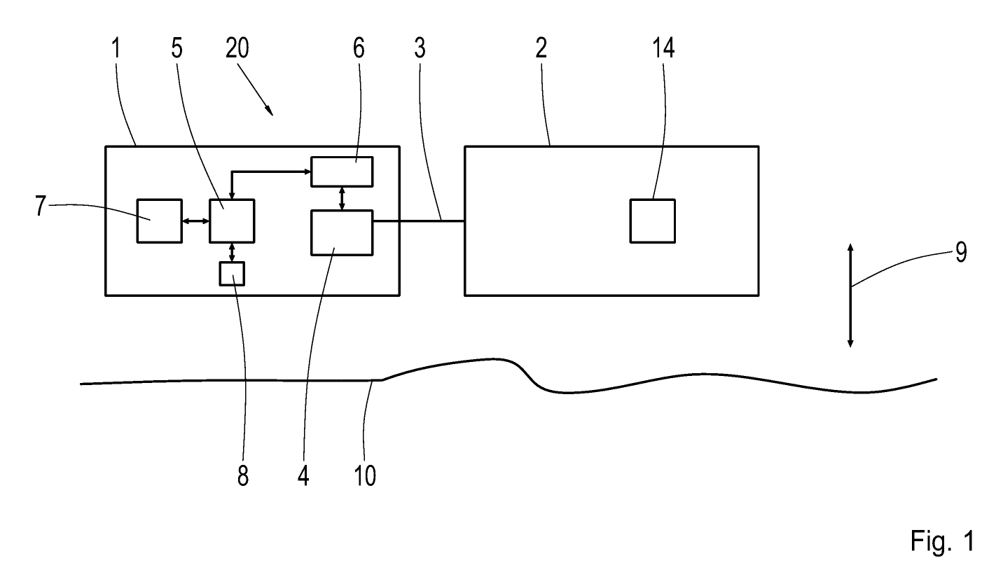

FIG. 1 shows a schematic view of a system 20 comprising an agricultural working vehicle 1 and a working device 2 operated along linear rows. The working vehicle 1 can be a tractor, a system vehicle (also known as a Trac vehicle), an equipment towing vehicle or a self-driving harvesting machine. The working device 2 is an attachment that can be fixed on the working vehicle 1 by corresponding holding means such as a front or rear powered hoist, or a feeder channel of a self-driving combine harvester, and carried by it, or towed by the working vehicle 1, such as a slurry tanker or the like. The working device 2 operates along linear rows, in other words maintaining lateral distances from adjacent linear rows to be worked and also complying with plant separation specifications.

The working device 2 is driven by a power take-off 4 of a transmission 3 of the working vehicle 1. To control the transmission 3 or the power take-off 4, the working vehicle 1 has a transmission control system 6. At least one sensor unit 14 is arranged on the working device 2. The index 9 denotes vertical movement of the working device 2 which it undergoes when driving over a field whose surface 10 is to be worked. The frequency and movement amplitude of the vertical movements 9, which also include vibrations of the working device 2, depend decisively on the surface condition of the field surface 10 being driven over and on the travel speed of the working vehicle 1 at the time, by which vehicle the working device 2 is being moved over the field surface 10.

A control unit 5 associated with the working vehicle 1 is connected for signal exchange with an output device 7, which serves to provide operating parameters at least of the working vehicle 1. In addition the control unit 5 is connected for signal exchange with the transmission control system 6 of the working vehicle 1 and with the at least one sensor unit 14 of the working device 2. In this case communication takes place by wiring means, for example via a CAN bus, or by wireless means via a radio network. Furthermore a position signal receiving unit 8 is provided, which is arranged on the working device 2. The position signal receiving unit 8 is connected for signal exchange with the control unit 5. The control unit 5 is arranged on the working vehicle 1. Alternatively the control unit 5 can be in the form of a portable data receiving device carried around by an operator of the working device 2. The portable data receiving device used can be for example a Smartphone or a Tablet PC. For this a corresponding program code is stored in the portable data receiving device, which is designed to evaluate the signals from the acceleration sensor 21 and to determine the maximum travel speed.

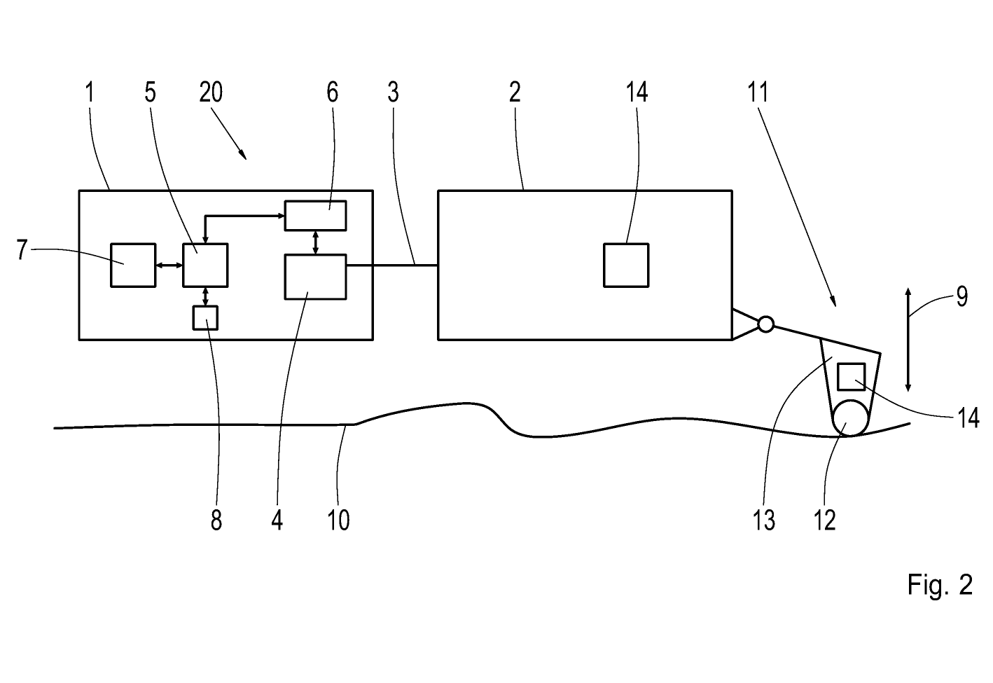

FIG. 2 shows a schematic view of the system 20 comprising the agricultural working vehicle 1 and a working device 2 operated along linear rows. On the working device 2 is arranged a sensing device 11. The sensing device 11 comprises a feeler wheel 12 linked to the working device 2 by a frame 13. The feeler wheel 12 follows the contour of the ground and therefore undergoes vertical deflections. A further sensor unit 14 is arranged on the frame 13.

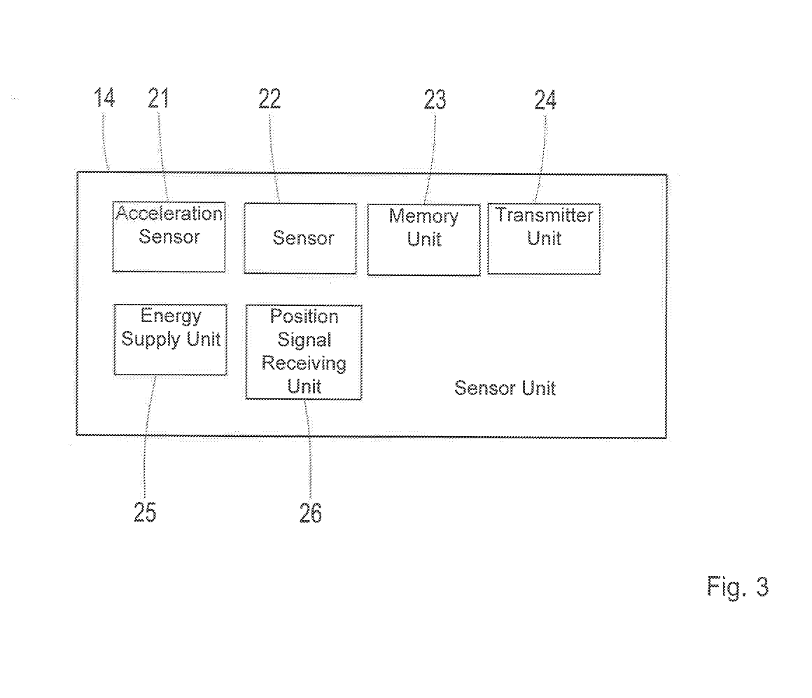

FIG. 3 shows a schematic representation of the structure of the sensor unit 14. The sensor unit 14 comprises an acceleration sensor 21, at least one additional sensor 22, a memory unit 23, a transmitter unit 24 and an energy supply unit 25. In addition a position signal receiver unit 26 can be provided. The memory unit 23 stores signals generated by the acceleration sensor 21 that represent vertical accelerations of the working device 2. By means of the acceleration sensor 21 the vertical movements 9 of the working device 2 and the sensing device 11 are recognized and registered continually. The transmitter unit 24, which works in accordance with the Bluetooth Low Energy radio standard, transmits the signals generated by the acceleration sensor 21 to the control unit 5. The at least one additional sensor 22 can be designed as a humidity and temperature sensor. The autonomously operating sensor unit 14 can be retrofitted to the working device 2. The possibility of retrofitting the sensor unit 14 has the advantage that it can also be used on older working devices 2.

To operate the system 20 it is provided that the signals from the acceleration sensor 21, which are registered continually and represent vertical accelerations, are sent to the control unit 5. The control unit 5 evaluates the signals from the at least one acceleration sensor 21 for the determination of movement amplitudes of the working device 2 and their frequency. On the basis of this evaluation, as a function of the movement amplitudes a maximum travel speed is determined, which during the movement over the field surface 10 to be worked ensures that the at least one working device 2 keeps to its linear rows and/or maintains the plant line separation. The maintenance of these distances, i.e. the precision with which the field surface 10 is worked, is important for achieving maximum yield and the best possible use of resources.

By way of example, the method according to the invention will be described with reference to a working device 2 in the form of a single-grain sowing machine. To achieve the greatest possible efficiency in working the field surface 10, a high travel speed is desirable. For this, the control unit 5 can set a constant travel speed at which the working vehicle 1 and the working device 2 arranged on it move over the field surface 10. Depending on the surface condition of the field surface 10 traveled over, the working device 2 designed as a single-grain sowing machine will undergo sudden accelerations, vertical movements 9 and/or vibrations of various amplitudes and frequencies. The resulting movements of the equipment for dispensing seeds lead to a serious loss of precision which at a later time is the cause of reduced crop yield. Since the movements of the working device are decisively governed by the surface condition of the field surface 10 being covered and by the travel speed of the working vehicle 1, the information about the movement amplitudes of the working device 2 is very important for the operator of the working vehicle 1 but above all for the control of the working vehicle 1 and the transmission 3. The maximum travel speed determined by the control unit 5, which enables precise operation of the working device 2 while complying with the boundary conditions, is used for the automatic adaptation of the travel speed of the working vehicle 1. This enables maximum efficiency, while maintaining the boundary conditions, to be achieved by operating the working device 2 with the necessary precision.

The maximum travel speed of the working vehicle 1 determined by the control unit 5 is displayed by the output device 7. In that way the operator can manually adapt the travel speed at the time to the maximum travel speed determined, if no automatic adaptation of the travel speed of the working vehicle 1 by the control unit 5 is possible.

Furthermore, the maximum travel speed of the working vehicle 1 determined can be displayed on the operator's portable data receiving device designed as the control unit 5. The operator can use that information in order to manually adapt the travel speed in an objective way by visualizing the measured values and the maximum travel speed determined, having regard to the condition of the ground and the movements of the working device 2. This can be desirable particularly with older working vehicles, since in general these do not have an electronic speed regulation system.

In addition position signals from a position location system are sent to the control unit 5, which are assigned by the control unit 5 to the respective signals received from the at least one acceleration sensor 21, which signals represent vertical accelerations. The position signals and also the signals registered by the acceleration sensor 21 are stored in the memory unit 23 of the sensor unit 14. Thus, these data can also be called up at a later time if, meanwhile, no control unit 5 designed for receiving data from the sensor unit 14 is within range of it.

An additional application of the sensor unit 14 arises from the recognition of various operating conditions of the working device 2. A distinction is made between operating conditions of the working device 2 such as storage, transport of the working device 2 to or between fields to be worked, and its actual use when operating on a field to be worked. In the storage case the sensor unit 14 does not supply any data from which it could be concluded that the working device 2 is moving. Correspondingly, the position signal receiving unit 8 does not register any position change of the working device 2. During transport of the working device 2 the acceleration sensor 21 detects specific measured values that are characteristic of transport by road. The same applies to the actual use of the working device 2 when working on a field. The distinction between the operating conditions with reference to the data received from the sensor unit 14 by the control unit 5 makes it possible to determine the actual number of hours operated.

A further application possibility arises in the case of a liquid-dispensing working device 2, if this has an additional sensor 22 for determining the filling level in the liquid container of the working device 2. The determination of the current filling level by the control unit 5 is used for the automatic control of the transmission control system 6. When the liquid container is full the working vehicle 1 is operated with settings of the transmission 3 different from those when the liquid container is half-empty or empty. Furthermore, the decreasing filling level in the liquid container of the working device 2 has an effect on the acceleration behavior when moving over an uneven field surface 10.

Each transmitter unit 24 is coded with a permanently assigned, clear address so that a particular working device 2 attached to the working vehicle 1 is identified as soon as the control unit 5 is within range of the sensor unit 14. In the control unit 5 or the transmission control system 6 specific parameters are stored for different working devices 2, which once the working device 2 has been identified are called up and adjusted before starting to use the working device 2. In that way, for example, a parameter for a maximum torque that can be transmitted to the working device 2 can be assigned.

### INDEXES

1 Working vehicle
2 Working device
3 Transmission
4 Power take-off
5 Control unit
6 Transmission control system
7 Output device
8 Position signal receiving unit
9 Vertical movement
10 Field surface
11 Sensing device
12 Feeler wheel
13 Frame
14 Sensor unit
20 System
21 Acceleration sensor
22 Sensor
23 Memory unit
24 Transmitter unit
25 Energy supply unit
26 Position signal receiving unit

1-13. (canceled)

14. A method of operating a system (20) comprising an agricultural working vehicle (1) and at least one working device (2) arranged thereon, and the at least one working device (2), when moving across a field, is operated along a current linear row, a control unit (5) being associated with the working vehicle (1) and at least one sensor unit (14) being arranged on the working device (2), the sensor unit having an acceleration sensor (21), a memory unit (23) and a transmitter unit (24), which wirelessly communicate with one another, the method comprising:
continually sending, via the at least one acceleration sensor (21), signals that represent vertical accelerations to the control unit (5),
evaluating the signals from the at least one acceleration sensor (21) to determine movement amplitudes of the working device (2), and
determining a maximum travel speed, as a function of the movement amplitudes, which ensures that the at least one working device (2) will stay on the current linear row while driving across the field.

15. The method according to claim 14, further comprising automatically adapting the travel speed of the working vehicle (2) by the control unit (5) to the determined maximum travel speed.

16. The method according to claim 14, further comprising displaying the maximum travel speed of the working vehicle (1), determined by the control unit (5), on an output device (7).

17. The method according to claim 14, further comprising sending position signals, received by a position location system, to the control unit (5), and the position signals are associated by the control unit (5) with the respective signals received from the at least one acceleration sensor (21) that represent vertical accelerations.

18. The method according to claim 17, further comprising mapping the movement amplitudes and frequencies by the control unit (5) with reference to the position signals received.

19. The method according to claim 14, further comprising evaluating the signals from the at least one acceleration sensor (21), by the control unit (5), in order to recognize an operating condition.

20. The method according to claim 14, further comprising assigning an individual recognition code, by which the working device (2) is identified by the control unit (5), to the transmitter unit (24) of the sensor unit (14) arranged on the working device (2).

21. The method according to claim 14, further comprising detecting a further physical magnitude by at least one further sensor (22) of the sensor unit (14).

22. A system (20) comprising:
an agricultural working vehicle (1),
at least one working device (2) arranged thereon, and the at least one working device (2), when moving across a field, being is operated along a current linear row,
a control unit (5) being associated with the working vehicle (1), and
at least one sensor unit (14) being arranged on the working device (2) which comprises an acceleration sensor (21), a memory unit (23) and a transmitter unit (24), which wirelessly communicate with one another, the at least one acceleration sensor (21) continually transmitting signals that represent a vertical acceleration to the control unit (5), which is designed to evaluate the signals from the at least one acceleration sensor (21) in order to determine movement amplitudes of the working device (2) and, as a function of the movement amplitudes, to determine a maximum travel speed which ensures that the working device (2) will stick to the current linear row while moving over the field.

23. The system (20) according to claim 22, wherein the sensor unit (14) can be retrofitted onto the working device (2).

24. The system (20) according to claim 22, wherein the sensor unit (14) comprises at least one further sensor (22) for detecting a further physical magnitude.

25. A control unit (5) for a system (20) comprising an agricultural working vehicle (1) and at least one working device (2) arranged thereon, which when moving across a field is operated along linear rows, the control unit (5) being associated with the working vehicle (1) and at least one sensor unit (14) being arranged on the working device (2), the sensor unit having an acceleration sensor (21), a memory unit (23) and a transmitter unit (24), which wirelessly communicate with one another, wherein the control unit (5) is designed to carry out a method for operating the system (20) including continually sending, with the at least one acceleration sensor (21), signals that represent vertical accelerations to the control unit (5); evaluating the signals from the at least one acceleration sensor (21) to determine movement amplitudes of the working device (2), and determining a maximum travel speed as a function of the movement amplitudes, which ensures that the at least one working device (2) will stay on a current linear row while driving across the field.

26. The control unit (5) according to claim 25, wherein the control unit (5) is designed to control a transmission control system (6).
